(19) United States
(12) Patent Application Publication
(10) Pub. No.: US 2017/0206862 A1
(43) Pub. Date: Jul. 20, 2017

(54) METHOD OF REGULATING BRIGHTNESS OF A DISPLAY SCREEN

(71) Applicant: Samsung Electronics Co., Ltd., Suwon-si (KR)

(72) Inventors: Krishna Kishor JHA, Bangalore (IN); Raghu Ballappa BANKAPUR, Bangalore KA (IN); Vaisakh Punnekkattu Chirayil SUDHEESH BABU, Bangalore (IN); Mahammadrafi MANIYAR, Bangalore (IN)

(21) Appl. No.: 15/259,629

(22) Filed: Sep. 8, 2016

(30) Foreign Application Priority Data
Jan. 20, 2016 (IN) 1266/CHE/2015

(51) Int. Cl. G09G 5/30; G06F 3/01; G09G 3/34; G09G 5/10

(52) U.S. Cl. CPC G09G 5/30; G09G 5/10; G06F 3/013; G09G 3/3406; G09G 2320/103; G09G 2330/021; G09G 2320/0686; G09G 2360/16; G09G 2320/0626; G09G 2320/066

(57) ABSTRACT

Example embodiments herein achieve a method of regulating brightness of a display screen of an electronic device. The method may include detecting, by a controller, a content change rate of at least one region of the display screen of the electronic device over a predetermined time period, and regulating, by the controller, at least one display parameter corresponding to the at least one region of the display screen.

### CROSS-REFERENCE TO RELATED APPLICATION

This application claims the benefit of Indian Application Number 1266/CHE/2015 filed with the Indian Patent Office on Jan. 20, 2016, the disclosure of which is incorporated herein in its entirety by reference.

### BACKGROUND

1. Field of the Invention

Example embodiments of the present disclosure relate to brightness regulation, and more particularly, to a mechanism for regulating brightness of a display screen of an electronic device.

2. Description of the Related Art

Generally, an electronic device is provided with a color thin-film transistor (TFT) liquid crystal display (LCD). The LCD having a LCD panel does not illuminate itself and thus requires a light source. A transmissive LCD uses a backlight, which is one of the greediest consumers of power of all components of an electronic device. A reflective LCD uses an ambient light source and a reflector instead of a backlight. However, a reflective LCD is not suitable for quality displays, and complementary use of an ambient light source and a backlight, named a transflective LCD, is used for electronic devices.

Electronic devices are constantly being developed for low power consumption, for example, to extend battery life. For LCD-based electronic devices, 90% of power consumption is attributed to the backlight, and accordingly, reducing power consumption by the backlight is considered one of the most effective ways to reduce LCD energy dissipation.

Many researchers have put considerable effort into developing backlight-dimming technologies under local, scanning, and global backlight structures for LCD-based electronic devices. Backlight-dimming technologies in both local and scanning backlight structures have been proposed to reduce power consumption in large backlight modules. However, such backlight structures are complex, come at a high-cost, and are unsuitable for small LCD-based electronic devices. Therefore, backlight-dimming technology based on a global dimming structure has been developed and investigated by researchers. Although this kind of backlight structure is used for electronic devices, the contrast reserve technique (with seven sophisticated steps) and dynamic backlight dimming technique do not elaborate on the amount of power saving achieved and how image contrast enhancement is improved. Other useful techniques for reducing backlight power consumption while retaining original image quality include average brightness detection and gray-level peak detection, but these schemes result in high image distortion. Another technique is a brightness preserving bi-histogram equalization approach for achieving contrast enhancement, but this approach has been found to be too complex and suffers from image distortion in a hue and saturation color space. Existing techniques intending to achieve better brightness control also suffer from significant shortcomings such as inter-frame brightness distortion, flickering effects, clipping artifacts, color distortions, or the like.

Thus, it is desired to address the above mentioned disadvantages or other shortcomings or at least provide a useful alternative.

### OBJECT OF INVENTION

The principal object of the example embodiments herein is to provide a method of regulating brightness of a display screen of an electronic device.

Another object of the example embodiments herein is to provide a mechanism for detecting, by a controller, a content change rate of at least one region of a display screen of an electronic device over a time period.

Another object of the example embodiments herein is to provide a mechanism for regulating, by a controller, at least one display parameter corresponding to at least one region of the display screen.

Another object of the example embodiments herein is to provide a mechanism for detecting, by a gaze detector, a region of the display screen which the user is looking at.

Another object of the example embodiments herein is to provide a mechanism for regulating, by a controller, at least one display parameter corresponding to remaining regions of the display screen.

### SUMMARY

Example embodiments herein achieve a method of regulating brightness of a display screen of an electronic device. The method may include detecting, by a controller, a content change rate of at least one region of the display screen of the electronic device over a predetermined time period. Further, the method may include regulating, by the controller, at least one display parameter corresponding to the at least one region of the display screen.

Example embodiments herein achieve a method of regulating brightness of a display screen of an electronic device. The method may include detecting, a gaze detector, a gaze of a user on a region in at least one portion of the display screen of the electronic device. Further, the method may include regulating, by a controller, at least one display parameter corresponding to remaining regions of the display screen.

Example embodiments herein disclose an electronic device for regulating brightness of a display screen. The electronic device may include a controller coupled to a storage unit. The controller may detect a content change rate of at least one region of the display screen of the electronic device over a time period. The controller may regulate at least one display parameter corresponding to the at least one region of the display screen.

Example embodiments herein disclose an electronic device for regulating brightness of a display screen. The electronic device may include a controller coupled to a storage unit. The controller may detect a gaze of a user on a region in at least one portion of the display screen of the electronic device. The controller may regulate at least one display parameter corresponding to remaining regions of the display screen.

Example embodiments herein disclose a computer program product including a computer executable program code recorded on a computer readable non-transitory storage medium. The computer executable program code when executed causing the actions including detecting, by a controller, a content change rate of at least one region of a display screen of an electronic device over a time period. The computer executable program code when executed causing the actions including regulating, by the controller, at least one display parameter corresponding to the at least one region of the display screen.

Example embodiments herein disclose a computer program product including a computer executable program code recorded on a computer readable non-transitory storage medium. The computer executable program code when executed causing the actions including detecting, a gaze detector, a gaze of a user on a region in at least one portion of a display screen of an electronic device. The computer executable program code when executed causing the actions includes regulating, by a controller, at least one display parameter corresponding to remaining regions of the display screen.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF FIGURES

This disclosure is illustrated in the accompanying drawings, throughout which like reference letters indicate corresponding parts in the various figures. The example embodiments herein will be better understood from the following description with reference to the drawings, in which:

FIG. 1 shows a simple user interface (UI) of a main screen of an electronic device in which brightness of a device display is regulated, according to the prior art;

FIG. 2 shows a simple UI of a main screen of an electronic device in which brightness of a device display is regulated, according to an example embodiment as disclosed herein;

FIG. 3 illustrates various units included in an electronic device, according to an example embodiment as disclosed herein;

FIG. 4 is a schematic of a controller for regulating brightness of a display screen of an electronic device, according to an example embodiment as disclosed herein;

FIG. 5 shows a location of different nodes in a Self-Organizing Map (SOM), according to an example embodiment as disclosed herein;

FIG. 6 is a color-rich image used for a Color Distribution Coefficient (CDC) computation process, according to an example embodiment as disclosed herein;

FIG. 7 is a normal image used for a CDC computation process, according to an example embodiment as disclosed herein;

FIG. 8 is a three-dimensional (3D) scatter plot showing color pixel values in a color-rich image, according to an example embodiment as disclosed herein;

FIG. 9 is a 3D scatter plot showing color pixel values in a normal image, according to an example embodiment as disclosed herein;

FIG. 10A is a flow diagram illustrating a method of regulating brightness of a display screen of an electronic device, based on a detected Content Change Rate (CCR) of a region of the display screen of the electronic device over a predetermined time period, according to an example embodiment as disclosed herein;

FIG. 10B is a flow diagram illustrating a method of regulating brightness of a display screen of an electronic device based on an aggressiveness parameter, based on a detected CCR of a region of the display screen of the electronic device over a time period, according to an example embodiment as disclosed herein;

FIG. 11A is a flow diagram illustrating a method of regulating brightness of a display screen of an electronic device, based on a point or region on the display screen which a user is looking at, according to an example embodiment as disclosed herein;

FIG. 11B is a flow diagram illustrating a method of regulating brightness of a display screen of an electronic device based on an aggressiveness parameter, a detected gaze of a user, and a determination of a point or region on the display screen which the user is looking at, according to an example embodiment as disclosed herein.

FIG. 12A is a flow diagram illustrating a method of regulating brightness of a display screen of an electronic device based on an aggressiveness parameter, according to an example embodiment as disclosed herein;

FIG. 12B is a flow diagram illustrating a method of computing an intensity level and a backlight level based on an aggressiveness parameter, according to an example embodiment as disclosed herein;

FIG. 13 illustrates an example illustration of an electronic device in which brightness of a display screen is regulated, based on a detected CCR of a region of the display screen over a time period, according to an example embodiment as disclosed herein;

FIG. 14 illustrates an example illustration of an electronic device in which brightness of a display screen is regulated, based on a point or region on the display screen which a user is looking at, according to an example embodiment as disclosed herein; and

FIG. 15 illustrates a computing environment implementing a mechanism for regulating brightness of a display screen, according to an example embodiment as disclosed herein.

### DETAILED DESCRIPTION OF INVENTION

The embodiments herein and the various features and advantageous details thereof are explained more fully with reference to the non-limiting example embodiments that are illustrated in the accompanying drawings and detailed in the following description. Descriptions of well-known components and processing techniques are omitted so as to not unnecessarily obscure the example embodiments herein. Also, the various example embodiments described herein are not necessarily mutually exclusive, as some example embodiments may be combined with one or more other example embodiments to form new example embodiments. The term “or” as used herein, refers to a non-exclusive or, unless otherwise indicated. The examples used herein are intended merely to facilitate an understanding of ways in which the example embodiments herein may be practiced and to further enable those skilled in the art to practice the example embodiments herein. Accordingly, the examples should not be construed as limiting the scope of the example embodiments herein.

The example embodiments herein provide a method of regulating brightness of a display screen of an electronic device. The method may include detecting, by a controller, a content change rate of at least one region of the display screen of the electronic device over a predetermined time period. Further, the method may include regulating, by the controller, at least one display parameter corresponding to the at least one region of the display screen.

In an example embodiment, the method may include computing a color distribution coefficient of the at least one region of the display screen. Further, the method may include determining an aggressiveness parameter based on a power saving level and at least one of the content change rate and the color distribution coefficient. Further, the method may include regulating the at least one display parameter corresponding to the at least one region of the display screen based on the aggressiveness parameter.

In an example embodiment, the display parameters may include at least one of a backlight level, an intensity level, a power saving level, and a contrast of the determined region.

The example embodiments herein provide a method of regulating brightness of a display screen of an electronic device. The method may include determining, by a gaze detector, a region of the display screen which the user is looking at. Further, the method may include regulating, by a controller, at least one display parameter corresponding to remaining regions of the display screen.

In an example embodiment, the method may include computing at least one of a content change rate and a color distribution coefficient of each of the remaining regions of the display screen. Further, the method may include determining an aggressiveness parameter based on a power saving level and at least one of the content change rates and the color distribution coefficients. Further, the method may include regulating the at least one display parameter corresponding to the remaining regions of the display screen based on the aggressiveness parameter.

The proposed method governs backlight scaling and content luminosity adjustment to reduce power consumption in a backlight module. The systems and methods of the related art intending to achieve similar results have significant shortcomings such as inter-frame brightness distortion, flickering effects, clipping artifacts, color distortion, or the like. These problems are addressed in the proposed method, in which user's visual perception is not compromised, image fidelity is ensured (less than 6.2% degradation), and current consumption is reduced by nearly 80 mA. The proposed method derives an aggressiveness parameter from a color distribution value and a content change rate, so as to reduce the power consumption in an effective manner. The aggressiveness parameter may be, for example, a parameter which limits change in brightness of a region or regions of the display screen of the electronic device.

Unlike the systems and methods of the related art, the proposed method drives a Content Change Rate Based Coefficient (CCRC) to restrict frequent backlight modifications, thereby reducing flickering effects and inter-frame distortion by 88%. A classification model for classifying an image into a color-rich and a simple user interface (UI) with 93% accuracy is modeled. The pixel level modifications to a displayed image are based on the classification to ensure the minimum color distortion. A content change rate and color distribution coefficient based technique is modeled to achieve high power savings when content on the display is a Simple UI (not color-rich) and less dynamic. Display content adjustment and backlight control is performed dynamically based on the content characteristics.

Unlike the systems and methods of the related art, the proposed method provides an adaptive dimming technique along with an effective backlight-dimming technique and a pragmatic contrast enhancement technique, so as to regulate the brightness of the display of the electronic device in an effective manner. In the proposed method, the backlight-dimming and the contrast enhancement techniques are executed simultaneously and implemented by inputting content, thereby reducing backlight power and improving an image contrast ratio. The proposed method reduces power consumption by 40%.

The proposed method provides intensity and a backlight adjustment, based on a content change rate, to optimize the battery power of an electronic device without affecting perceived brightness level or while maintaining the same brightness. The proposed method provides for quick detection of whether a device is idle based on the content change rate on a display and regulation of the brightness level of the backlight illumination without affecting the user experience.

Unlike the systems and methods of the related art, the proposed method provides a deceptive brightness technique to simultaneously enhance image contrast ratio, reduce image distortion, and reduce power consumption by the backlight for global backlight applications, all while maintaining the same perceived brightness. The proposed method controls Hue, Saturation, Intensity (HSI) values based on characteristics of the content.

The proposed method reduces the power consumption of the electronic device upon detecting static/slowly changing content displayed on a display screen. The proposed method reduces the power consumption of the electronic device upon detecting a region of the display screen including static/slowly changing content. According to the proposed method, the electronic device may reduce its backlight level by increasing pixel intensity and contrast simultaneously, without affecting perceived brightness level.

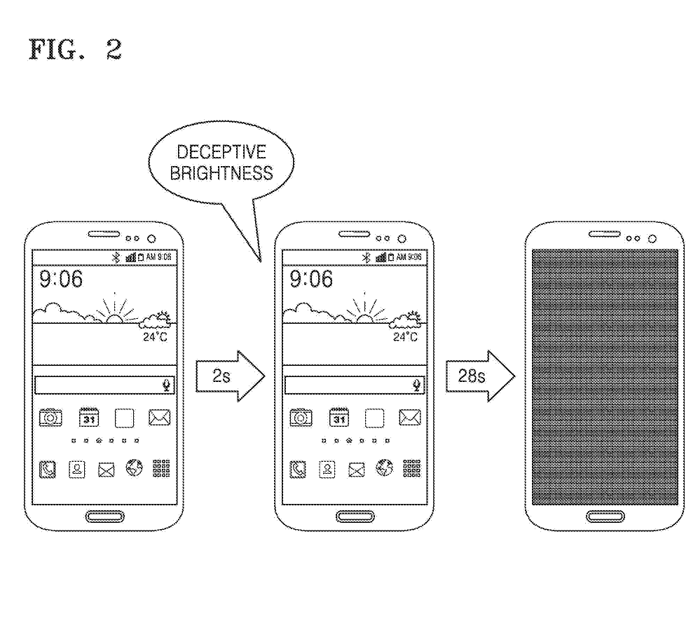

Referring now to the drawings and more particularly to FIGS. 2 through 15, where similar reference characters denote corresponding features consistently throughout the figure, there are shown example embodiments.

Energy conservation to extend battery life is a major challenge for sustaining richer user experiences in electronic devices. A Content Change Rate Coefficient (CCRC) and image Color Distribution Coefficient (CDC) based method is proposed for governing backlight scaling and image luminosity adjustment to reduce power consumption in a backlight module. The existing methods intending to achieve similar results have significant shortcomings such as inter-frame brightness distortion, flickering effects, clipping artifacts, and color distortion. These problems are addressed in the proposed technique, in which the user's visual perception is not compromised, image fidelity is ensured, and current consumption is reduced by nearly 80 mA. The proposed method derives an aggressiveness parameter from color distribution and content change rate to address the above problems.

The images on a display may be classified into two types of images—a Color-rich image and a simple UI. Color-rich images have wide color distribution, whereas a simple UI consists of few colors. For instance, UIs of an Alarm Clock, a Contacts Application, etc. are examples of simple UI images, and photos/videos are examples of color-rich images.

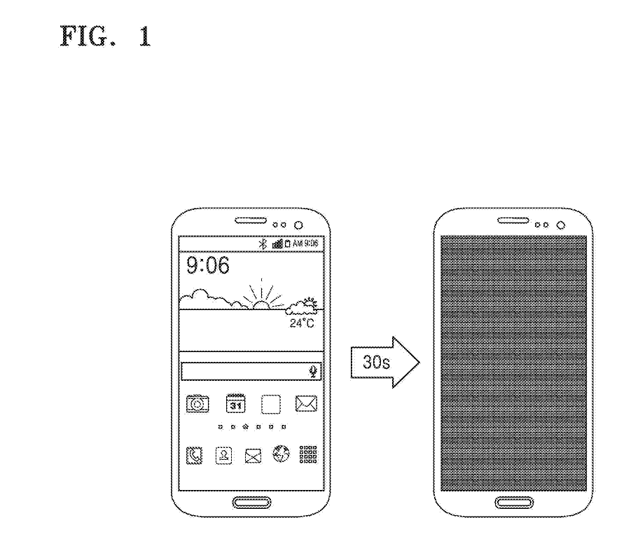

FIG. 1 shows a simple user interface (UI) of a main screen of an electronic device in which brightness of a device display is regulated, according to the prior art. As shown in FIG. 1, initially the electronic device consumes 317 mA power at a backlight level of 250. After detecting a frame is idle for a predetermined time, the mechanism of the related art regulates the usage power of the display. Based on the detection of whether the frame is idle, the electronic device consumes 3 mA power at a backlight level of 0. The existing method takes a minimum of 30 seconds to detect the idle state and trigger the power save mode of the electronic device. The proposed method minimizes image distortion in the case of images which are color-rich, and at the same time tries to save more power in the case of images which are static/slowly changing, for example, simple UIs.

FIG. 2 shows the simple UI of the main screen of the electronic device in which brightness of the device display is regulated, according to an embodiment as disclosed herein. Unlike the systems of the related art, a Content Change Rate Coefficient (CCRC) and an image Color Distribution Coefficient (CDC) based technique is adapted to govern backlight scaling and image luminosity adjustment to reduce power consumption in a backlight module.

The proposed method detects the ideal state and applies the deceptive brightness technique to save the power of the electronic device. In the proposed method, static conditions of the device display are computed based on the CCRC and the CDC of a frame displayed on the electronic device. A point where the frame remains unchanged for more than a predetermined time, for example, 2 seconds may be considered as a start point for deceptive brightness. The proposed method switches to a deceptive brightness mode in response to detecting an idle state of 2 seconds or more. Hence, the proposed method may initiate a power saving mode, for example, the deceptive brightness mode, after 2 seconds, which is advantageous compared to conventional mechanisms. The proposed method gives flexibility to a user for saving power, with a tradeoff being slight image degradation. This may be very useful when the user's device is running low on power. Further, the details of the proposed mechanism are described in conjunction with FIGS. 2 through 13.

Before describing the proposed technique, it is necessary to understand the relationship between brightness, backlight, power consumption and intensity of content. The content may be an image, a video, multimedia, or the like. For an LCD-based electronic device, the backlight is a main source for the brightness, measured in lux, coming out of the LCD, and 90% of the power consumption by the device is attributed to the backlight. There are different techniques to control brightness of the LCD such as backlight-based brightness control and image intensity based brightness control. Saving power merely by reducing the backlight leads to reduction in brightness. Instead, saving power by a combination of pixel-level contrast enhancement and backlight dimming will improve the user experience.

The backlight is the main source of light, and fragmentary directed light passing through pixels depends on intensity value. The perceived intensity of the content as displayed on the display of the electronic device is denoted by equation (1).

I=βLY_{fr} (1)

In equation (1), β is the transmittance of a LCD Panel, L is a backlight luminance, and Yfr is the average luminance value of the frame. ‘L’ may be controlled linearly by a Backlight Level (BL) and ‘Y_{fr}’ may be controlled by increasing/decreasing the Luma component for the frame, referred to as Image Intensity Level (IL). Concurrent adjustment of the intensity and backlight level may lead to energy conservation, but modifying only these parameters may cause distortion in the displayed image.

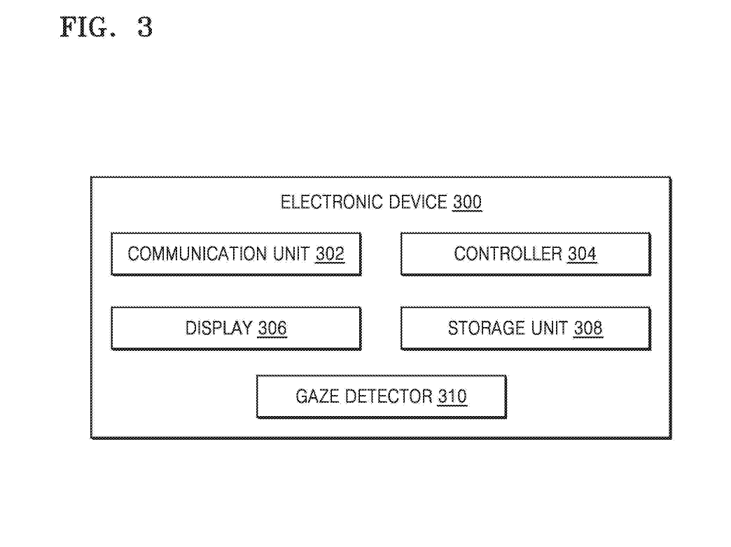

FIG. 3 illustrates various units included in an electronic device 300, according to an example embodiment as disclosed herein. The electronic device 300 may be, for example, but is not limited to, a notebook computer, a palm-size personal computer (PC), a personal data assistant (PDA), a cell phone, a smart phone, a mobile computing device, a messaging device, a mini-computer, a main frame computer, a supercomputer, a network appliance, a web appliance, a distributed computing system, a multiprocessor system, a processor-based system, a television, a digital television, an alarm clock, a navigation system, an automotive interior lighting and dashboard illumination, a kitchen appliance (e.g., microwave oven, refrigerator), a wireless access point, base station, a subscriber station, or the like. In an example embodiment, the electronic device 300 may include a communication unit 302, a controller 304, a display 306, a storage unit 308, and a gaze detector 310. The communication unit 302 may be configured for communication internally between internal units and with external devices via one or more networks. In an example embodiment, the controller 304 may detect a Content Change Rate (CCR) of at least one region of a display screen over a predetermined time period. The controller 304 may further compute a Color Distribution Coefficient (CDC) for the at least one region of the display screen. The controller 304 may determine the aggressiveness parameter based on a power saving level (e.g., a selected power saving level) and at least one of the CCR and the CDC. Based on an aggressiveness parameter, the controller 304 may regulate at least one display parameter corresponding to the at least one region of the display screen. The display parameter may be, for example, but is not limited to, the backlight level, the intensity level, the power saving level, the contrast of the region, or the like.

In an example embodiment, the gaze detector 310 may detect that the user is looking at the display screen, and further, determine a point or region on the display screen which the user is looking at. The gaze detector 310 may be, for example, a sensor or camera. The controller 304 may compute at least one of the CCR and the CDC corresponding to remaining regions of the display screen. Further, the controller 304 may determine the aggressiveness parameter based on the power saving level and at least one of the CCR, the CDC or a combination of both. Based on an aggressiveness parameter, the controller 304 may regulate the at least one display parameter corresponding to the remaining regions of the display screen.

The display 306 may display information for the user on the display screen. To assist the user in viewing the displayed information, the display 306 may have a backlight arranged to emit light of varying levels of brightness or luminance. The amount of brightness may vary for any number of reasons. In an example, the user may use one or both of the applications to automatically manage brightness levels based on any number of user defined settings. In an example, the user may define a setting to control the amount of time a backlight for the display 306 remains active following receipt of a user input by an input/output unit. This may be desirable to conserve power provided by the battery. The user may also manually adjust brightness levels to accommodate different types of displayed information or ambient light conditions.

The electronic device 300 may control the display 306 using a display control module (not shown). The display control module may control operations for the display 306. As the display 306 consumes a relatively large amount of power relative to other components of the electronic device 300, the display control module may coordinate with a power management module (not shown) in order to implement various power conservation techniques. Further, the display control module may send control directives to the power management module to increase or decrease power supplied to the display 306 to increase or decrease brightness levels of the display 306.

The electronic device 300 may provide the user with various global or application preferences for illuminating the display 306. The user may view, input, and modify the brightness preferences using an input/output (I/O) device such as keyboard, mouse, or the like. After being input by the user, the brightness preferences may be stored in the storage unit 308 or other suitable computer-readable storage media.

The controller 304 is coupled to the storage unit 308. The storage unit 308 may store the luminance (lux) value at the back-light level (BLc) by indexing into a mapping table. The storage unit 308 may include one or more computer-readable storage media. The storage unit 308 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage unit 308 may, in some examples, be a non-transitory storage medium. The term “non-transitory” indicates that the storage medium is not embodied in a carrier wave or a propagated signal. However, the term “non-transitory” should not be interpreted that the storage unit 308 is non-movable. In certain examples, a non-transitory storage medium may store data that can, over time, change (e.g., in Random Access Memory (RAM) or cache).

The electronic device 300 may reduce backlight level by increasing pixel intensity and contrast simultaneously, thus reducing power consumption with little to no difference in user perceived brightness on the display screen.

Although FIG. 3 shows exemplary units included in the electronic device 300, it is to be understood that other example embodiments are not limited thereto. In other example embodiments, the electronic device 300 may include less or more units than illustrated. Further, the labels or names of the units are used only for illustrative purpose and do not limit the scope of the disclosure. One or more units may be combined together to perform the same or substantially similar function to regulate the brightness of the display 306.

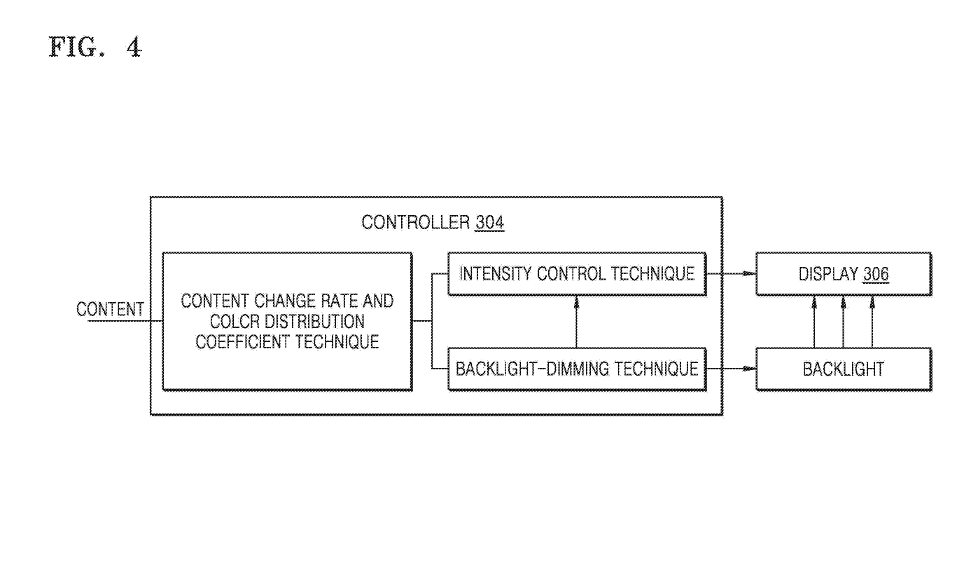

FIG. 4 is a schematic of the controller 304 for regulating brightness of the display screen, according to an example embodiment as disclosed herein. In an example embodiment, the controller 304 may detect the change in a frame displayed on the electronic device 100. Based on the change in the frame, the controller 104 may compute the CCR, the CDC or a combination of both by using a content change rate and a color distribution coefficient technique. The content change rate and the color distribution coefficient technique utilize a Self-Organizing Map (SOM) based technique used for the CDC classification.

### CDC Classification:

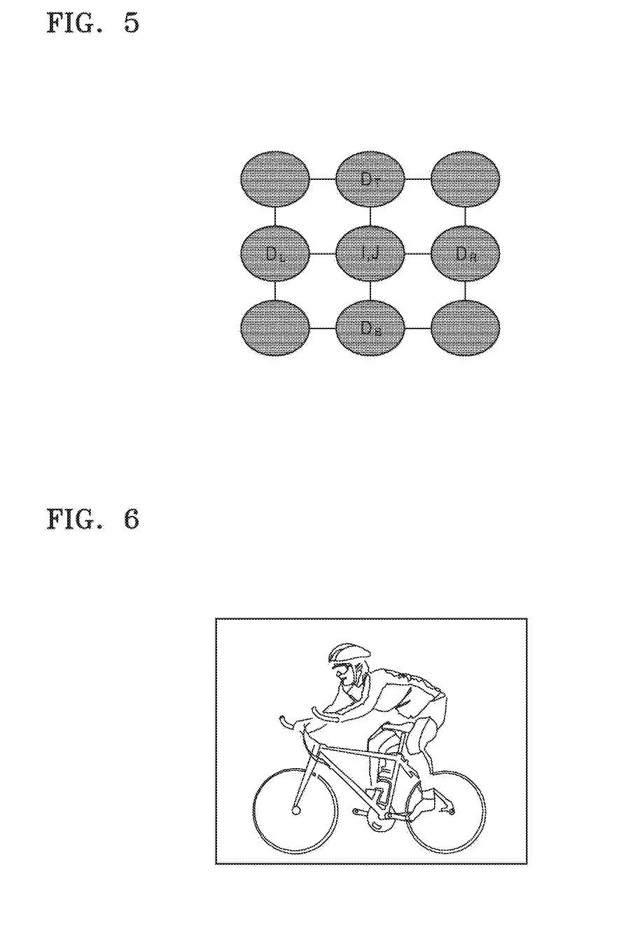

The SOM based technique is an unsupervised neural network based dimension reduction technique. Each node in the SOM has a weight vector having a dimension equal to the dimension of an input data. In an example, a rectangular SOM may be visualized as a rectangular mesh of n×m nodes. Consider a 3×3 rectangular SOM explained in accordance with FIG. 5. The length of each line connecting the nodes is a Euclidean distance between the weights of the nodes. The SOM exhibits a property that it maintains an original data topology, i.e. similar items are mapped to nearby nodes. As a result of this topology preservation, when the SOM is trained with input data, the SOM tries to take the shape of data distribution. For example, consider an imaginary image having pixel values. When the pixel values are plotted in a three-dimensional (3D) scatter plot, the plot takes the shape of a sphere. If the rectangular SOM is trained with these image pixel values as an input, the rectangular SOM mesh plot will also take the shape of a sphere. This property of the SOM is harnessed here to make the color distribution estimation. A 6×6 rectangular SOM is created which is trained with pixel values of input image.

The training techniques for the SOM are described as below:
Step 1: Initialize the weight vectors W(I, J) with random values
Step 2: Determine the winner neuron Wc(t) for an input pixel x of the content using an Euclidean distance formula
Step 3: Update the weight vectors using equation (2)

Wᵢ(t+1)=Wᵢ(t)+α(t)h_{ci}(t)[x(t)−Wᵢ(t)] (2)
where α is learning rate and h_{ci} is a neighborhood Gaussian function given by equation (3).

$${h}_{ci} = exp ( - \frac{{‖ rc - ri ‖}^{2}}{2 {o ( t )}^{2}} ) \qquad ( 3 )$$

In equation (3), the ∥rc−ri∥² is the distance between the position (x, y) of the winning node and an i^{th} node in the rectangular SOM map.

The neighborhood radius (o(t)) and learning rate (α (t)) also decay with the time, according to the below decay function (4).

$$L ( t ) = {L}_{0} exp ( - \frac{t}{N} ) \qquad ( 4 )$$

Step 4: Repeat steps 2 and 3 until total iteration count is reached.

Based on the process, it is inferred that the stretch of the SOM correctly represents the color distribution in the content (i.e., image). This observation of difference in the Color distribution is used as an objective criteria to classify Color-rich and Simple user interface (UI) content. The Color Distribution Metric (CDM) may be derived from the equation (5)

CDM=Σᵢ₌₀ⁱ⁼⁶Σⱼ₌₀^{j=6}D_{L}(I,J)+D_{T}(I,J)+D_{B}(I,J)+D_{R}(I,J) (5)

where D_{L}, D_{B}, D_{R}, D_{T} are the Euclidean distances of weights in the SOM from the node (I,J) in the SOM map from the left, top, bottom and right nodes, respectively. FIG. 5 shows the locations D_{L}, D_{B}, D_{R}, D_{T} of the nodes in the SOM.

The CDM represents the amount by which the SOM map is spread, and hence a high value of the CDM implies color-rich content whereas a low value indicates a lower number of colors (i.e., simple UI). The CDC is derived from the CDM using equation (6), and Tₕ is a CDM threshold for the color-rich content. The value of Tₕ is determined experimentally as it depends on the resolution of the content.

$$CDC = \{ \begin{matrix}( 1 - \frac{CDM}{{T}_{h}} ) if CDM \leq {T}_{h} \\ 0 if CDM > {T}_{h}\end{matrix} \qquad ( 6 )$$

The classification model for classifying the content into the color-rich and the simple user interface (UI) with 93% accuracy is modeled. The pixel level modifications to displayed content are based on the classification to ensure minimum color distortion and eliminate the artifacts used to reduce chromatic distortion. The content change rate and color distribution coefficient based technique is modeled to achieve high power saving when content on the display is simple UI (not color-rich) and less dynamic.

### Content Change Rate Coefficient (CCRC):

In an example embodiment, the content change rate and color distribution coefficient technique may utilize a display content change analysis technique. The display content change analysis technique may be explained in terms of the CCR that is derived based on the frame submission rates to the display 306. In an example, in a video player application, and in a gaming application, the CCR will be high as content in such cases changes at a high rate. In an example, for a launcher application, a contacts application, or a call application, the CCR will be low. Hence, the content change rate analysis is done to calculate the CCR intensity based on which content intensity adjustment and backlight control is performed.

In an example embodiment, the CCR is calculated based on the number of frames updated per unit time as measured in frames per second.

In an example embodiment, the CCRC is computed based on the CCR. The CCRC calculation for different CCRs is shown in the Table 1.

TABLE 1

| Sl. No. | CCR | CCRC |
|---|---|---|
| 1 | More than 60 | 0 |
| 2 | 45 to 60 | 1 |
| 3 | 30 to 44 | 2 |
| 4 | 20 to 29 | 3 |
| 5 | 10 to 19 | 4 |
| 6 | 8 to 9 | 5 |
| 7 | 6 to 7 | 6 |
| 8 | 4 to 5 | 7 |
| 9 | 2 to 3 | 8 |
| 10 | 1 or less | 9 |

In an example embodiment, the controller 304 may perform an intensity control technique based an Effective Aggressiveness.

The CCRC restricts frequent backlight modifications, thereby reducing the flickering effects and the inter-frame distortion by 88%.

### Computation of Effective Aggressiveness:

The Effective Aggressiveness (A_{eff}) including the CCRC, an Aggressiveness (Aᵤ) and the CDC may be derived by using the equation (7)

A_{eff}=CCRC*max(CDC,Aᵤ)) (7)

where
0≦A_{eff}≦9
0 means no power saving
9 means highest power saving.

The proposed technique may provide more flexibility to the user for manually setting power saving which is more aggressive. This may be very useful when the user is running out of battery power. The Table 2 shows a representation of power saving aggressiveness based on a user power level selection.

TABLE 2

| Sl. No. | User power saving level | Aᵤ |
|---|---|---|
| 1 | Low | 0.5 |
| 2 | Medium | 0.7 |
| 3 | High | 1 |

### Computation of the Intensity Level and the Backlight (BL) Level Based on an Aggressiveness Parameter:

The technique for computing the intensity level and the backlight level based on an aggressiveness parameter is explained below: The below steps are performed by the controller 304.
Step 1: Determine a current backlight level.
Step 2: Obtain the luminance (lux) at the back-light level (BLc) by indexing into a mapping table (i.e., LUX_TABLE).

LUX_{c}=LUX_TABLE(BL_{c},0) (8)
Step 3: Identify the luminance in the mapping table for all backlight levels less than the current backlight level and higher intensity levels as per the below matching function to create a mapping array (i.e., LUXMAP_ARRAY)

LUXMAP_ARRAY (BL,IL)=search (LUX_{c},threshold,LUX_TABLE);
where
For all BL<BL_{c} and IL>0
Search(X, threshold, T(x,y)) is a function which returns all sets of {x,y} for which the value T(x, y)=X±threshold.
This generates an array of BL, IL pairs producing the same amount of lux.

In an example embodiment, the same lux may be produced with different combinations of the backlight and intensity. Hence, the LUXMAP_ARRAY may be an array of BL and IL pairs which produce same LUXc.
Step 4: Select a combination of the intensity level and the backlight level from the mapping array using the aggressiveness parameter.

[BLₙ,ILₙ]=LUXMAP_ARRAY [A_{eff}]

where
BLₙ is new backlight level to be applied
ILₙ is new Intensity level to be applied.

The calculated BLₙ and ILₙ levels may be applied to a backlight subsystem and a display frame to achieve better power saving without compromising display quality. The proposed method obtains the backlight saving effect, while maintaining the same perceived brightness by adjusting the contrast and backlight levels. The proposed method is more useful and effective in simultaneously enhancing the content contrast ratio, reducing the content distortion and saving the backlight power.

Although FIG. 4 shows exemplary logic of the controller 304, it is to be understood that other example embodiments are not limited thereto. One or more logic functions or blocks may be combined together to perform the same or substantially similar function to regulate the brightness of the display 306.

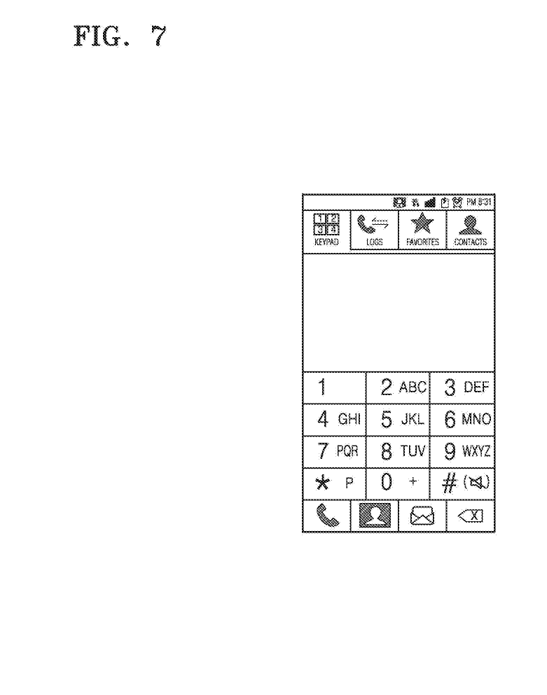

FIG. 6 is a color-rich image used for the CDC computation process, according to an example embodiment as disclosed herein. FIG. 7 is a normal image used for the CDC computation process, according to an example embodiment as disclosed herein;

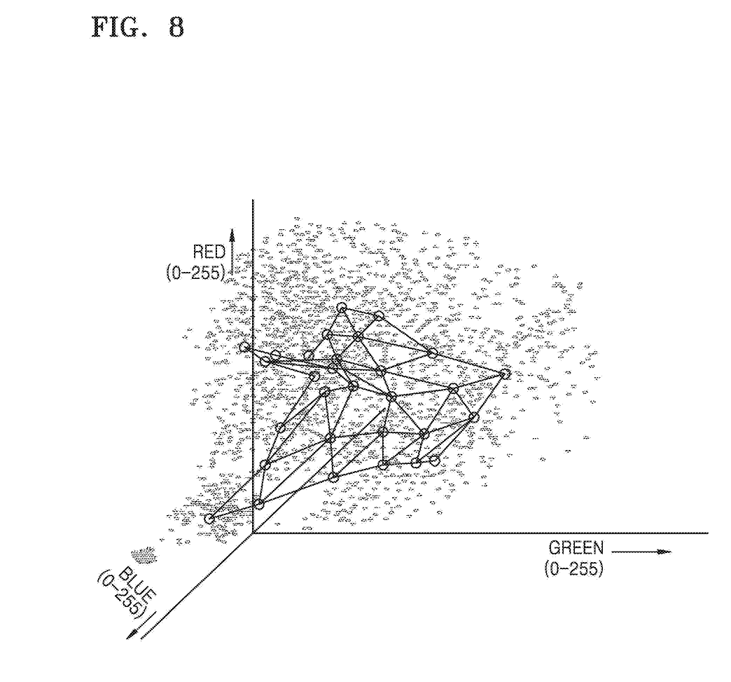

FIG. 8 is a 3D scatter plot showing color pixel values in the color-rich image of FIG. 6, according to an example embodiment as disclosed herein. FIG. 8 also shows the SOM (black mesh) which is obtained after training. FIG. 8 illustrates how the SOM has taken the shape of the input distribution.

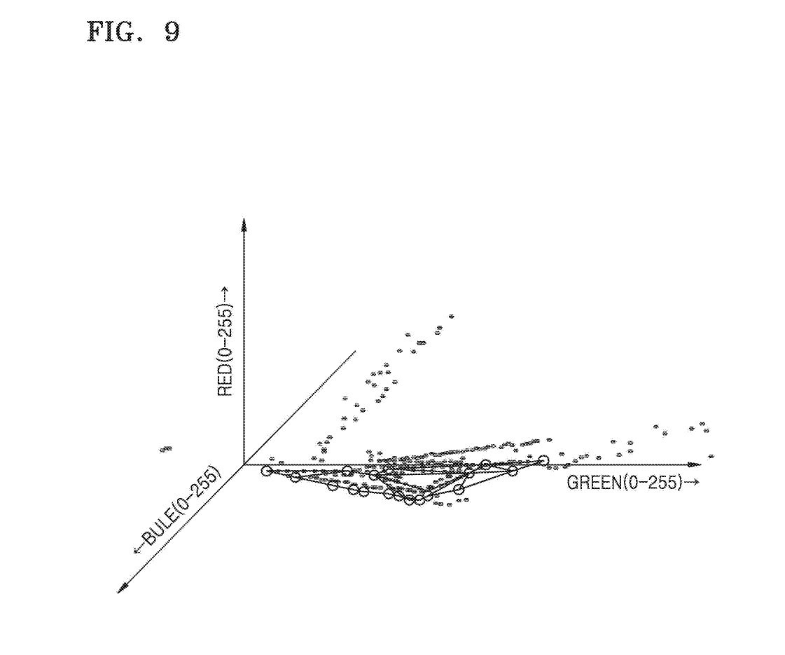

FIG. 9 is a 3D scatter plot showing the color pixel values in the normal image of FIG. 7, according to an example embodiment as disclosed herein. The scatter plot of FIG. 9 is mostly concentrated in one region and is considerably less stretched than the scatter plot of FIG. 8, as the normal image of FIG. 7 has a smaller number of colors than the color-rich image of FIG. 6. In FIG. 8, the SOM is more stretched, showing that the distribution of color in FIG. 6 is higher.

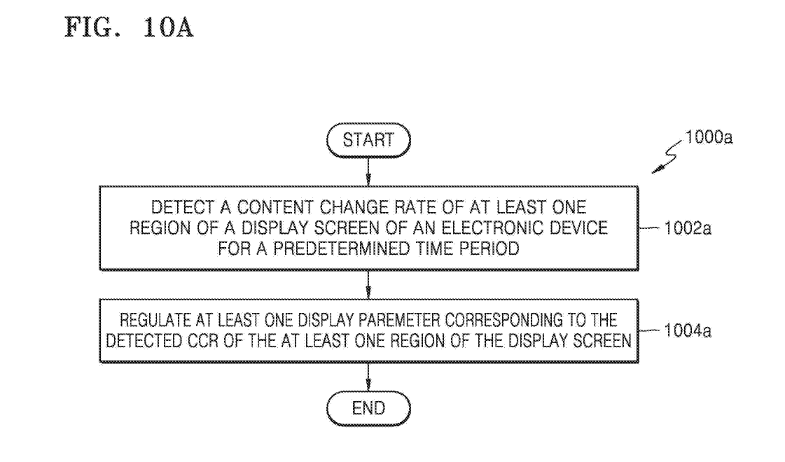

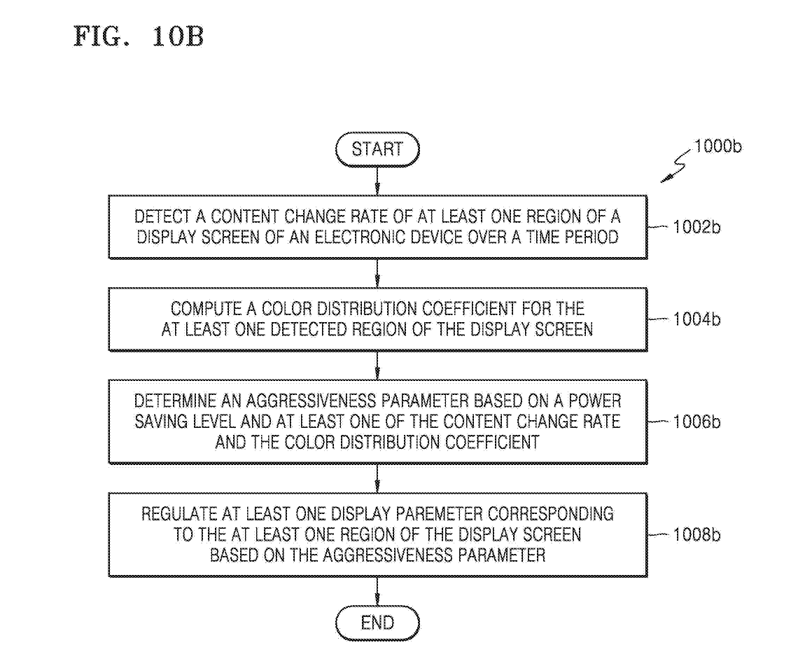

FIG. 10A is a flow diagram illustrating a method 1000a for regulating brightness of the display screen of the electronic device 300, based on a detected CCR of a region of the display screen of the electronic device over a time period, according to an example embodiment as disclosed herein. At step 1002a, the method 1000a may include detecting the content change rate of at least one region of the display screen for a predetermined time period. In an example embodiment, in the method 1000a, the controller 304 may detect the content change rate of at least one region of the display screen for a preset time period. At step 1004a, the method 1000a may include regulating at least one display parameter corresponding to the detected content change rate of the at least one region of the display screen. The display parameter may be, for example, but is not limited to, the backlight level, the intensity level, the power saving level, the contrast of the region, or the like. In an example embodiment, in the method 1000a, the controller 304 may regulate at least one display parameter corresponding to the at least one region of the display screen.

The proposed method 1000a may govern backlight scaling and content luminosity adjustment to reduce power consumption in a backlight module. The methods of the related art intending to achieve similar results have significant shortcomings such as inter-frame brightness distortion, flickering effects, clipping artifacts, color distortion, and the like. These problems are addressed in the proposed method 1000a, in which the user's visual perception is not compromised, image fidelity is ensured, and current consumption is reduced by nearly 80 mA. The method 1000a derives an aggressiveness parameter from a color distribution value and a content change rate, so as to reduce the power consumption in an effective manner.

In an example, the electronic device 300 may include multiple windows—a first window having high dynamic content, and a second window having static/slowly changing content. Whether the content is high dynamic content or static/slowly changing may be determined based on the content change rate. The deceptive brightness mode is activated for the second window to regulate the brightness of the display screen based on an aggressiveness parameter.

When content displayed by the electronic device 300 is static/slowly changing content (e.g., content which slowly changes over a period of time), the electronic device 300 may reduce the backlight and increase pixel intensity and contrast. This reduces power consumption, and also the user cannot see a difference in brightness level.

In an example, if a region of an upper window of the display screen overlaps a region of a lower window of the display screen, the deceptive brightness parameter of the window having the higher content change rate is also applied to the overlapping regions as well. For example, the brightness of the backlight for the window having the higher content change rate is also applied to the overlapping regions. This ensures display brightness uniformity in the display screen.

The various actions, acts, blocks, steps, or the like in the method 1000a may be performed in the order presented, in a different order, or simultaneously. Further, in some example embodiments, some of the actions, acts, blocks, steps, or the like may be omitted, added, modified, skipped, or the like without departing from the scope of the invention.

FIG. 10B is a flow diagram illustrating a method 1000b for regulating brightness of the display screen of the electronic device 300 based on an aggressiveness parameter, based on a detected CCR of a region of the display screen of the electronic device over a predetermined time period, according to an example embodiment as disclosed herein. At step 1002b, the method 1000b may include detecting the CCR of at least one region of the display screen over a time period. In an example embodiment, in the method 1000b, the controller 304 may detect the CCR of at least one region of the display screen for the time period. At step 1004b, the method 1000b may include computing the CDC for the at least one region of the display screen. In an example embodiment, in the method 1000b, the controller 304 may compute the CDC for the at least one region of the display screen. At step 1006b, the method 1000b may include determining the aggressiveness parameter based on the power saving level and at least one of the CCR and the CDC. In an example embodiment, in the method 1000b, the controller 304 may determine the aggressiveness parameter based on the power saving level and at least one of the CCR and the CDC. At step 1008b, the method 1000b may include regulating at least one display parameter corresponding to the at least one region of the display screen based on an aggressiveness parameter. In an example embodiment, in the method 1000b, the controller 304 may regulate at least one display parameter corresponding to the at least one region of the display screen based on an aggressiveness parameter.

The method 1000b enhances the user's experience by saving power without degrading the visual quality of the display screen.

The various actions, acts, blocks, steps, or the like in the method 1000b may be performed in the order presented, in a different order or simultaneously. Further, in some example embodiments, some of the actions, acts, blocks, steps, or the like may be omitted, added, modified, skipped, or the like without departing from the scope of the invention.

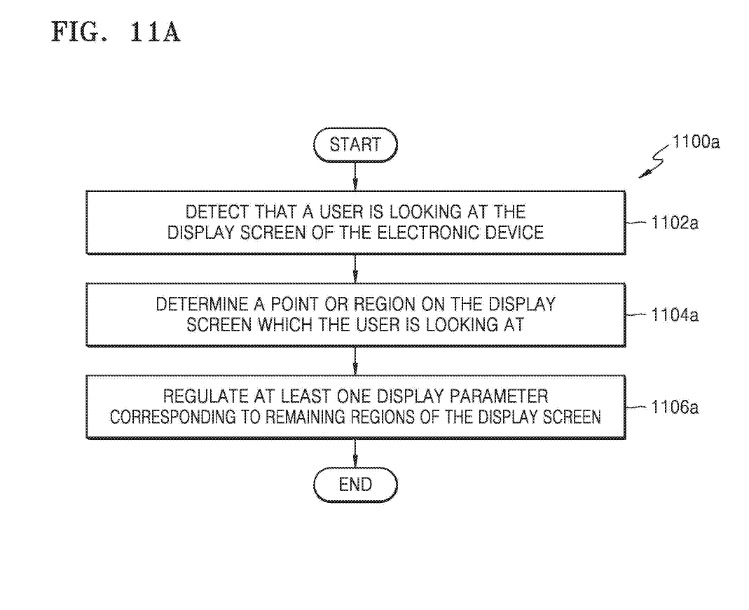

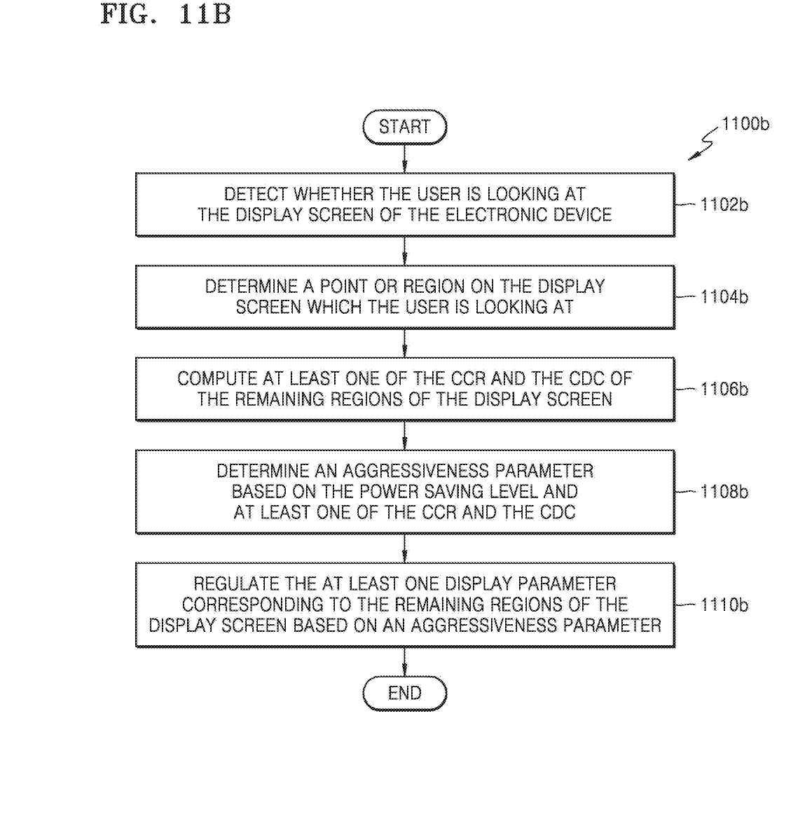

FIG. 11A is a flow diagram illustrating a method 1100a for regulating brightness of the display screen of the electronic device 300, based on a point or region on the display screen which a user is looking at, according to an example embodiment as disclosed herein. At step 1102a, the method 1100a may include detecting that the user is looking at the display screen of the electronic device 300, and further at step 1104a, determining a point or region on the display screen which the user is looking at. In an example embodiment, in the method 1100a, the gaze detector 310 may detect that the user is looking at the display screen of the electronic device 300, and further, determine a point or region on the display screen which the user is looking at. At step 1106a, the method 1100a may include regulating at least one display parameter corresponding to remaining regions of the display screen. In an example embodiment, in the method 1100a, the controller 304 may regulate at least one display parameter corresponding to remaining regions of the display screen.

In an example, when a user is viewing a display screen on which static/slow changing content is displayed, the gaze detector 310 may detect that the user is looking at the display screen of the electronic device 300, and further, determine a point or region on the display screen which the user is looking at. Based on, for example, a detected region, the gaze detector 310 may enable the deceptive brightness mode so as to regulate the brightness of remaining regions of the display screen of the electronic device 300.

The various actions, acts, blocks, steps, or the like in the method 1100a may be performed in the order presented, in a different order or simultaneously. Further, in some example embodiments, some of the actions, acts, blocks, steps, or the like may be omitted, added, modified, skipped, or the like without departing from the scope of the invention.

FIG. 11B is a flow diagram illustrating a method 1100b for regulating brightness of the display screen of the electronic device 300 based on an aggressiveness parameter, based on a detected gaze of a user (e.g., the detection of whether the user is looking at the display screen and the direction in which the user is looking), and further, a determination of a point or region on the display screen which the user is looking at, according to an example embodiment as disclosed herein. At step 1102b and step 1104b, the method 1100b may include detecting whether the user is looking at the display screen of the electronic device 300 and determining a point or region on the display screen which the user is looking at. In an example embodiment, in the method 1100b, the gaze detector 310 may detect that the user is looking at the display screen of the electronic device, and further, determine a region of the display screen which the user is looking at. At step 1106b, the method 1100b may include computing at least one of the CCR and the CDC of the remaining regions of the display screen. In an example embodiment, in the method 1100b, the controller 304 may compute at least one of the CCR and the CDC corresponding to the remaining regions of the display screen. At step 1108b, the method 1100b may include determining an aggressiveness parameter based on the power saving level and at least one of the CCR and the CDC. In an example embodiment, in the method 1100b, the controller 304 may determine the aggressiveness parameter based on the power saving level and at least one of the CCR and the CDC. At step 1110b, the method 1100b may include regulating the at least one display parameter corresponding to the remaining regions of the display screen based on an aggressiveness parameter. In an example embodiment, in the method 1100b, the controller 304 may regulate the at least one display parameter corresponding to the remaining regions of the display screen based on an aggressiveness parameter.

The various actions, acts, blocks, steps, or the like in the method 1100b may be performed in the order presented, in a different order or simultaneously. Further, in some example embodiments, some of the actions, acts, blocks, steps, or the like may be omitted, added, modified, skipped, or the like without departing from the scope of the invention.

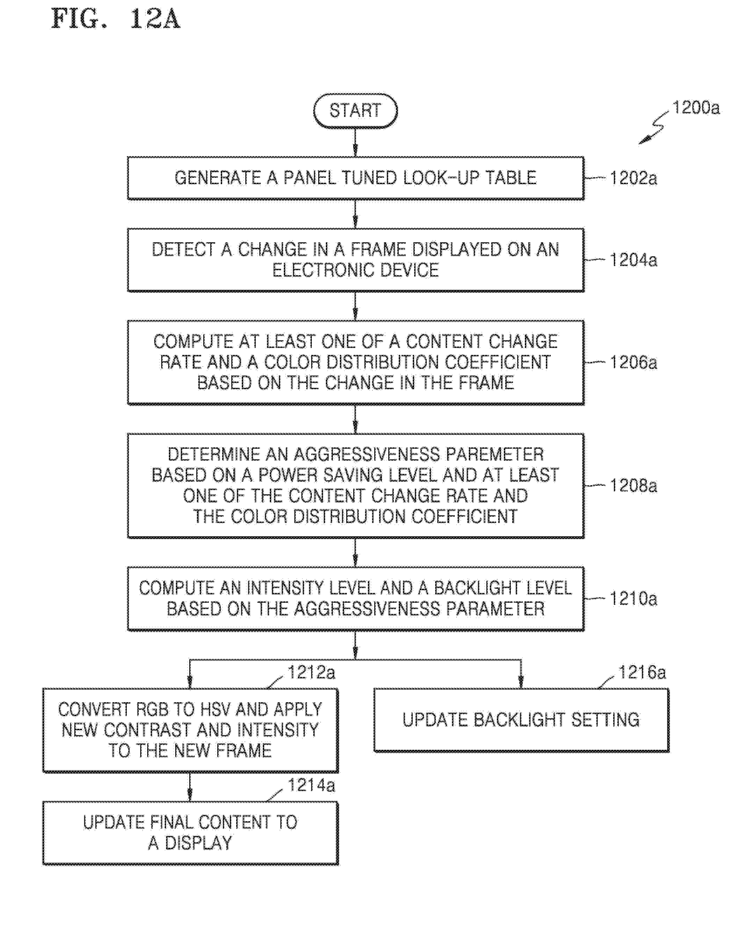

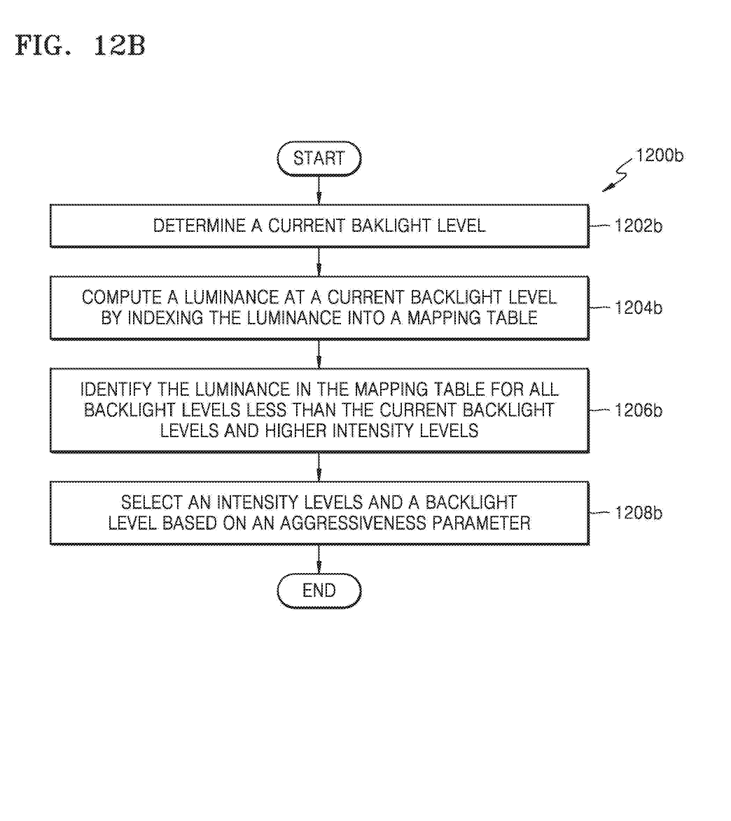

FIG. 12A is a flow diagram illustrating a method 1200a for regulating brightness of the display screen of the electronic device 300 based on an aggressiveness parameter, according to an example embodiment as disclosed herein. At step 1202a, the method 1200a may include generating a panel-tuned lookup table. In an example embodiment, in the method 1200a, the controller 304 may generate the panel-tuned lookup table.

In an example embodiment, in the method 1200a, the controller 304 may display a uniform gray image on the display 306 for tuning a brightness table. The gray image is taken for readings since Red-Green-Blue (RGB) distribution is uniform in the gray color image. Further, the controller 304 may measure the Luminescence (lux) for all backlight levels from bl=0 to bl=255 and Intensity Levels varying from il=0 to il=25 and generate the panel-tuned lookup table (i.e., LUX_TABLE [255][25] table) accordingly. In Table 3 below, backlight levels bl=0 and 25, Intensity Levels il=0, 1 and 25, and measured lux values LUX_TABLE [0], [0] to [0], [25] are shown.

TABLE 3

| | Intensity | | | |
|---|---|---|---|---|
| Backlight | il = 0 | il = 1 | . . . | il = 25 |
| bl = 0 | LUX_TABLE | LUX_TABLE | | LUX_TABLE |
| | [0], [0] | [0], [1] | | [0], [25] |
| . . . | . . . | . . . | . . . | . . . |
| bl = 25 | LUX_TABLE | LUX_TABLE | . . . | LUX_TABLE |
| | [255], [0] | [255], [1] | | [255], [25] |

At step 1204a, the method 1200a may include detecting for any changes in the frame displayed on the electronic device 300. In an example embodiment, in the method 1200a, the controller 304 may detect for any changes in the frame displayed on the electronic device 300. At step 1206a, the method 1200a may include computing the content change rate, the color distribution coefficient, or a combination of both based on changes in the frame. In an example embodiment, in the method 1200a, the controller 304 may compute the content change rate, the color distribution coefficient or a combination of both based on changes in the frame. At step 1208a, the method 1200a may include determining the aggressiveness parameter based on the power saving level and at least one of the content change rate and the color distribution coefficient. In an example embodiment, in the method 1200a, the controller 304 may determine the aggressiveness parameter based on the power saving level and at least one of the content change rate and the color distribution coefficient. At step 1210a, the method 1200a may include computing the intensity level and the backlight level based on an aggressiveness parameter. In an example embodiment, in the method 1200a, the controller 304 may compute the intensity level and the backlight level based on an aggressiveness parameter. At step 1212a, the method 1200a may include converting the RGB to a Hue-Saturation-Value (HSV) and applying new contrast and intensity to the new frame. In an example embodiment, in the method 1200a, the controller 304 may convert the RGB to HSV and apply new contrast and intensity to the new frame. At step 1214a, the method 1200a may include displaying the content on the display screen according to the finalized contrast and intensity values. In an example embodiment, in the method 1200a, the controller 304 may display the content on the display screen according to the finalized contrast and intensity values. At step 1216a, the method 1200a may include updating the backlight setting. In an example embodiment, in the method 1200a, the controller 304 may update the backlight setting.

The proposed method 1200a drives the CCRC to restrict frequent backlight modifications, thereby reducing the flickering effects and the inter-frame distortion by 88%. A classification model for classifying the content into the color-rich and a simple user interfaces (UIs) with 93% accuracy is modeled. The pixel level modifications to displayed content are based on the classification to ensure minimum color distortion and eliminate the artifacts used to reduce chromatic distortion. The content change rate and color distribution coefficient based technique is modeled to achieve high power saving when content on the display is simple UI (not color-rich) and less dynamic.

The various actions, acts, blocks, steps, or the like in the method 1200a may be performed in the order presented, in a different order or simultaneously. Further, in some example embodiments, some of the actions, acts, blocks, steps, or the like may be omitted, added, modified, skipped, or the like without departing from the scope of the invention.

FIG. 12B is a flow diagram illustrating a method 1200b for computing the intensity level and the backlight level based on an aggressiveness parameter, according to an example embodiment as disclosed herein. At step 1202b, the method 1200b may include determining the current backlight level. In an example embodiment, in the method 1200b, the controller 304 may determine the current backlight level. At step 1204b, the method 1200b may include computing the luminance at the current backlight level by indexing the luminance into a mapping table. In an example embodiment, in the method 1200b, the controller 304 may compute the luminance at the current backlight level by indexing the luminance into a mapping table. At step 1206b, the method 1200b may include identifying the luminance in the mapping table for all backlight levels less than the current backlight level and higher intensity levels. In an example embodiment, in the method 1200b, the controller 304 may identify the luminance in the mapping table for all backlight levels less than the current backlight level and higher intensity levels. At step 1208b, the method 1200b may include selecting an intensity level and a backlight level based on an aggressiveness parameter. In an example embodiment, in the method 1200b, the controller 304 may select an intensity level and a backlight level based on an aggressiveness parameter.

The various actions, acts, blocks, steps, or the like in the method 1200b may be performed in the order presented, in a different order or simultaneously. Further, in some example embodiments, some of the actions, acts, blocks, steps, or the like may be omitted, added, modified, skipped, or the like without departing from the scope of the invention.

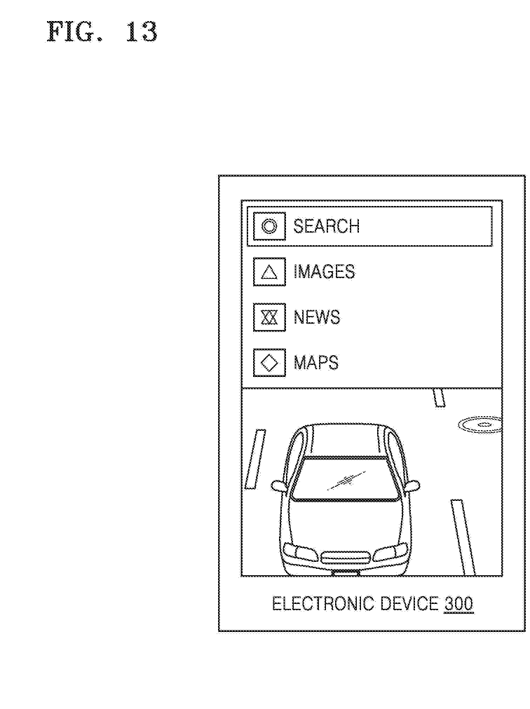

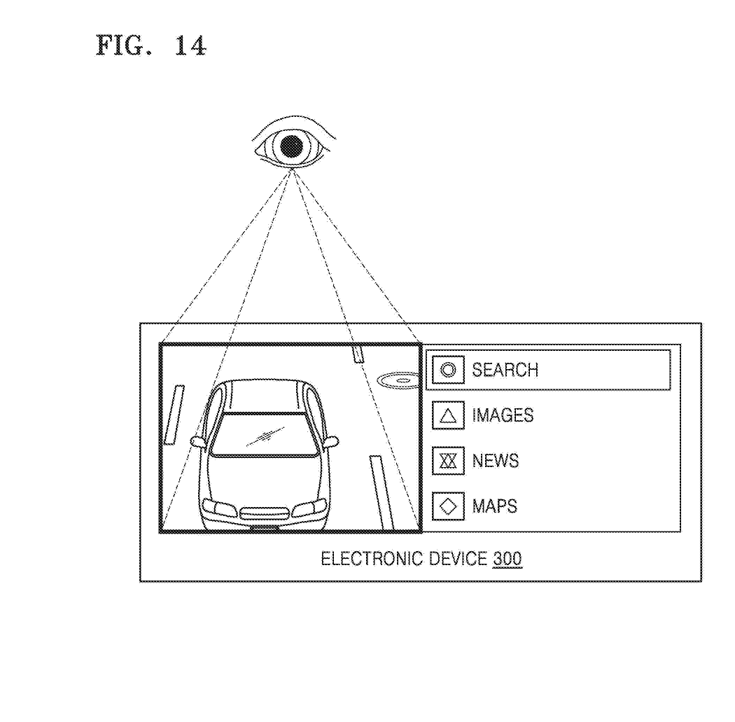

FIG. 13 illustrates an example illustration of an electronic device 300 in which brightness of the display screen is regulated, based on a detected CCR of a region of the display screen over a time period, according to an example embodiment as disclosed herein. The electronic device 300 detects the CCR of the first portion of the display screen for the time period. After detecting the CCR on the first region of the display screen, the electronic device 300 computes the CDC for the region and determines the aggressiveness parameter. The electronic device 300 regulates the display parameter corresponding to the at least one region based on an aggressiveness parameter, so as to regulate the brightness of the first portion of the display screen in an effective manner.

FIG. 14 illustrates an example illustration of the electronic device 300 in which brightness of the display screen is regulated, based on a point or region on the display screen which a user is looking at, according to an example embodiment as disclosed herein. The gaze detector 310 may detect that the user is looking at the display screen, and further, determine a point or region on the display screen which the user is looking at. The electronic device 300 may compute the CCR and the CDC corresponding to remaining regions of the display screen. The electronic device 300 may regulate the display parameter corresponding to the remaining regions of the display screen to regulate the brightness of the remaining regions of the display screen.

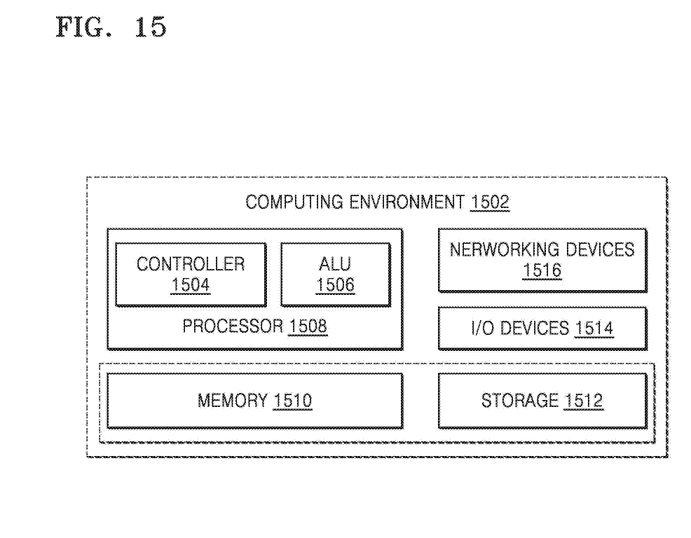

FIG. 15 illustrates a computing environment 1502 implementing a mechanism for regulating brightness of the display screen of the electronic device 300, according to an example embodiment as disclosed herein. As depicted in the figure, the computing environment 1502 may include at least one processor 1508 that is equipped with a controller 1504, an Arithmetic Logic Unit (ALU) 1506, a memory 1510, a storage 1512, a plurality of networking devices 1516, and a plurality of Input output (I/O) devices 1514. The processor 1508 is responsible for processing instructions for executing the techniques disclosed herein. The processor 1508 may receive control commands from the controller 1504 in order to perform the above processing. Further, any logical and arithmetic operations involved in the execution of the instructions may be computed with the help of the ALU 1506.

The overall computing environment 1502 may be composed of multiple homogeneous or heterogeneous cores, multiple kinds of CPUs, special media and other accelerators. Further, the plurality of processor 1504 may be located on a single chip or over multiple chips.

The technique comprising of instructions and codes required for the implementation may be stored in the memory 1510, storage 1512, or both. At the time of execution, the instructions may be fetched from the corresponding memory 1510 or storage 1512, and executed by the processor 1508.

In the case of any hardware implementations, various networking devices 1516 or external I/O devices 1514 may be connected to the computing environment 1502 to support the implementation through the networking unit and the I/O device unit.

The example embodiments disclosed herein may be implemented through at least one software program running on at least one hardware device and performing network management functions to control the elements. The elements shown in the FIGS. 2 to 15 include blocks, elements, actions, acts, steps, or the like which may be at least one of a hardware device, or a combination of hardware devices and software modules.

The foregoing description of the specific example embodiments will so fully reveal the general nature of the example embodiments herein that others can, by applying current knowledge, readily modify and or adapt for various applications such specific example embodiments without departing from the generic concept, and, therefore, such adaptations and modifications should and are intended to be comprehended within the meaning and range of equivalents of the disclosed example embodiments. It is to be understood that the phraseology or terminology employed herein is for the purpose of description and not of limitation. Therefore, while the example embodiments herein have been described in terms of example embodiments, those skilled in the art will recognize that the example embodiments herein may be practiced with modification within the spirit and scope of the example embodiments as described herein.

1. A method of regulating brightness of a display screen of an electronic device, the method comprising:
detecting, by a controller, a content change rate of at least one region of the display screen of the electronic device over a predetermined time period; and
regulating, by the controller, at least one display parameter corresponding to the at least one region of the display screen.

2. The method of claim 1, wherein the regulating the at least one display parameter corresponding to the at least one region of the display screen comprises:
computing a color distribution coefficient of the at least one region of the display screen;
determining an aggressiveness parameter based on a power saving level and at least one of the content change rate and the color distribution coefficient; and
regulating the at least one display parameter corresponding to the at least one region of the display screen based on the aggressiveness parameter.

3. The method of claim 2, further comprising:
computing the content change rate based on a number of frames updated per unit time in the at least one region of the display screen; and
determining whether content included in the at least one region of the display screen is dynamic content or static content.

4. The method of claim 3, further comprising:
reducing a backlight level, increasing pixel intensity, and contrast of the at least one region of the display screen based on the determination that the content is static content.

5. The method of claim 1, wherein the at least one display parameter comprises at least one of a backlight level, an intensity level, a power saving level, and contrast of the at least one region of the display screen.

6. An apparatus for regulating brightness of a display screen, the apparatus comprising:
a memory; and
a controller, coupled to the memory, configured to:
detect a content change rate of at least one region of a display screen of the apparatus over a predetermined time period; and
regulate at least one display parameter corresponding to the at least one region of the display screen.

7. The apparatus of claim 6, wherein the regulating the at least one display parameter corresponding to the at least one region of the display screen comprises:
computing a color distribution coefficient of the at least one region of the display screen;
determining an aggressiveness parameter based on a power saving level and at least one of the content change rate and the color distribution coefficient; and
regulating the at least one display parameter corresponding to the at least one region of the display screen based on the aggressiveness parameter.

8. The apparatus of claim 7, wherein the controller is further configured to:
compute the content change rate based on a number of frames updated per unit time in the at least one region of the display screen; and
determine whether content included in the at least one region of the display screen is dynamic content or static content.

9. The apparatus of claim 8, wherein the controller is further configured to:
reduce a backlight level, increase pixel intensity, and contrast of the at least one region of the display screen based on the determination that the content is static content.

10. The apparatus of claim 6, wherein the at least one display parameter comprises at least one of a backlight level, an intensity level, a power saving level, and contrast of the at least one region.

11. An electronic device for regulating brightness of a display screen, the electronic device comprising:
a memory;
a gaze detector configured to determine a region of a display screen of the electronic device which a user is looking at, and
a controller, coupled to the memory, configured to regulate at least one display parameter corresponding to remaining regions of the display screen.

12. The electronic device of claim 11, wherein, when the controller regulates the at least one display parameter corresponding to remaining regions of the display screen, the controller is further configured to:
compute at least one of a content change rate and a color distribution coefficient of each of the remaining regions of the display screen;
determine an aggressiveness parameter based on a power saving level and at least one of the content change rates and the color distribution coefficients; and
regulate the at least one display parameter corresponding to the remaining regions of the display screen based on the aggressiveness parameter.

13. The electronic device of claim 11, wherein the at least one display parameter comprises at least one of a backlight level, an intensity level, a power saving level, and contrast of the determined region.
